(19) United States
(12) Patent Application Publication
(10) Pub. No.: US 2014/0225467 A1
(43) Pub. Date: Aug. 14, 2014

(54) MAGNETIC GEAR MECHANISM WITH COILS AROUND PERMANENTLY EXCITED MAGNET POLES

(71) Applicants: Dieter Munz, Hochstadt (DE); Markus Reinhard, Nurnberg (DE)

(72) Inventors: Dieter Munz, Hochstadt (DE); Markus Reinhard, Nurnberg (DE)

(73) Assignee: Siemens Aktiengesellschaft, Munchen (DE)

(21) Appl. No.: 14/241,773

(22) PCT Filed: Aug. 31, 2011
(86) PCT No.: PCT/EP2011/065014

§ 371 Date: Feb. 27, 2014

(51) Int. Cl. H02K 49/10

(52) U.S. Cl. CPC H02K 49/10
USPC 310/101

(57) ABSTRACT

The dynamics of a magnetic gear mechanism are intended to be improved. For this purpose, a magnetic gear mechanism with a stator, a first rotor, which has permanently excited magnet poles (2, 3), and a second rotor, which likewise has permanently excited magnet poles, is proposed. The rotors are magnetically coupled to the stator. In each case one coil (5) is wound around each of the magnet poles (2, 3) of the first rotor. The coils (5) of the magnet poles (2, 3) are connected in series. The series circuit of the coils (5) can be supplied direct current in order to alter the magnetic flux through the magnet poles (2, 3) in comparison with the de-energized state.

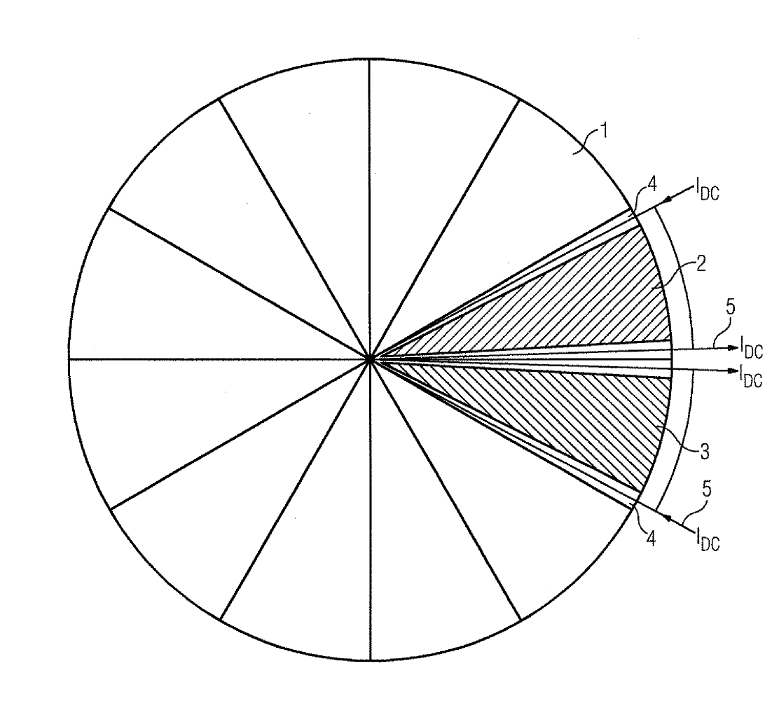

The present invention relates to a magnetic gear mechanism comprising a stator, a first rotor which has permanently excited magnet poles, and a second rotor which likewise has permanently excited magnet poles, wherein the rotors are magnetically coupled to the stator. The present invention further relates to a method for operating a magnetic gear mechanism which is constructed in the above manner.

What are known as “magnetic gear mechanisms” have been known for some time. They consist of at least two rotors (drive side and output side) and a stator. The rotors are fitted with permanent magnets with a different number of poles. The number of poles for each rotor is given by a design rule. The magnets are fitted on a magnetic return path.

The driven rotor generates a magnetic rotary field in the air gap (between the first rotor and the stator), said magnetic rotary field rotating in synchronism with the rotor depending on the number of poles. The stator is partially composed of soft-magnetic materials. Said materials are usually laminated iron or soft-magnetic compound materials (soft magnetic composites) or soft ferrite. The task of the stator is to modulate the magnetic alternating field from the drive side in a suitable manner, so that the field on the output side (in the second air gap between the stator and the output-side rotor) rotates at a different frequency. Therefore, the rotation speed can be varied (step-down) when the output-side rotor with the occurring number of poles is coupled.

In the case of implementations which have been known to date, the two rotors, irrespective of whether they have axial or radial flux guidance (disk-like or tubular design of the rotors) are fitted with permanent magnets (preferably composed of NdFeB) with a different number of poles, The magnets of the driven rotor (a disk in the case of axial arrangement and a tube in the case of radial arrangement) generate a rotating magnetic field which is modulated by the flux-guiding teeth in the stationary stator (likewise a disk or, respectively, a tube) and is then coupled on the output side to the field of the magnets on the second rotor (again a disk or tube). The transmission ratio is defined by selecting the number of magnets. Both step-down and step-up are possible. The intensity of the magnetic field defines the maximum possible torque. If this torque is exceeded, the gear mechanism falls out of sync. If the load torque falls below the critical torque, the gear mechanism re-synchronizes. It is not possible to control the behavior in the case of falling out of sync and in the case of synchronization. However, this would be desirable.

The object of the present invention is therefore to be able to vary the behavior of a magnetic gear mechanism in the case of falling out of sync and/or in the case of synchronization.

According to the invention, this object is achieved by a magnetic gear mechanism comprising a stator, a first rotor which has permanently excited magnet poles, and a second rotor which has permanently excited magnet poles, wherein the rotors are magnetically coupled to the stator, and wherein in each case one coil is wound around each of the magnet poles of the first rotor, the coils of the magnet poles are connected in series so as to correspond to a first series circuit, and direct current can be supplied to the first series circuit of the coils in order to change the magnetic flux through the magnet poles of the first rotor in comparison to the de-energized state.

The invention further provides a method for operating a magnetic gear mechanism, which has a stator, a first rotor which has permanently excited magnet poles, and a second rotor which has permanently excited magnet poles, wherein the rotors are magnetically coupled to the stator, by providing in each case one coil around each of the magnet poles of the first rotor, wherein the coils of the magnet poles are connected in series so as to correspond to a first series circuit, and supplying direct current to the first series circuit of the coils in order to change the magnetic flux through the magnet poles of the first rotor in comparison to the de-energized state.

Therefore, in each case one coil is advantageously wound around each magnet pole of the first rotor, and the coils will be/are connected in series to form a winding. Therefore, a direct current can be supplied to all of the coils of the first rotor, it being possible for the magnetic flux through the magnet poles to be varied in accordance with requirements using said direct current. Said magnetic flux can, for example, be weakened in the case of falling out of sync and intensified for synchronization.

In addition, in each case one coil is preferably wound around each of the magnet poles of the second rotor, the coils of the magnet poles are connected in series so as to correspond to a second series circuit for a second winding, and direct current can be supplied to the second series circuit of the coils in order to change the magnetic flux through the magnet poles of the second rotor in comparison to the de-energized state. As a result, the critical torque can be varied not only in the first rotor, but also in the second rotor of the gear mechanism.

The winding direction of each coil advantageously depends on the direction of magnetization of the permanent magnets of the respective magnet pole. As a result, the magnetic fluxes of all of the magnet poles can be intensified or weakened by one and the same direct current.

In particular, adjacent magnet poles can be magnetized in opposite directions by permanent magnets, and therefore have coils which have an opposite winding direction in relation to one another. As a result, the magnetizations of the magnet poles regularly alternate from one magnet pole to the other over the circumference of the rotor or of the rotors.

In particular, each of the magnet poles should have a soft-magnetic core. This has the advantage that the coils do not have to be wound around the permanent magnets which have approximately the relative permeability of air. Instead, the coils are in this case wound around a soft-magnetic core, so that a lower current intensity is required in order to achieve a desired magnetic flux.

The magnet poles of the first rotor can be arranged in the manner of segments on a soft-magnetic disk, wherein slots into which the coils are inserted are formed in the pole gaps. The coils are provided with a soft-magnetic core on account of this special construction.

In an advantageous refinement, the magnetic gear mechanism has a temperature sensor which outputs a temperature signal, and a first control device for controlling the direct current through the coils depending on the temperature signal. This has the advantage that a weakening in the field on account of an increase in temperature can be compensated.

Furthermore, the magnetic gear mechanism can have an overload sensor which outputs an overload signal, and a second control device for controlling the direct current through the coils depending on the overload signal. This has the advantage that the consequences of the overload (shaking or asynchronicity) can be eliminated more quickly.

Furthermore, the magnetic gear mechanism can have a third control device with which the current can be controlled through the coils such that the magnetic flux through the magnet poles during a prespecified start-up phase of the respective rotor is intensified in comparison to the de-energized state. As a result, it is possible to ensure that the magnetic gear mechanism is synchronized more rapidly during start-up.

The present invention will be explained in greater detail with reference to the appended drawing which schematically illustrates, in plan view, a disk-like rotor of a magnetic gear mechanism.

The exemplary embodiments which will be described in greater detail below constitute preferred embodiments of the present invention.

A magnetic gear mechanism of the kind cited in the introductory part has two rotors which are provided with permanent magnets which are composed of a specific magnet material. Since the maximum torque which can be transmitted is dependent on the field strength of the field and therefore mainly on the remanent induction B_{R} of the magnet material used, the “tilting moment” can no longer be varied after the production of the gear mechanism according to the prior art. However, the intention is for this to be possible with the magnetic gear mechanism according to the invention and, respectively, the method according to the invention for operating a gear mechanism of this kind.

Magnetic gear mechanisms are typically realized with tubular rotors or with disk-like rotors. The example in the FIGURE shows a plan view of a disk-like rotor. In the present case, said rotor is a 12-pole rotor. Each pole is of segmented design. A pole pitch 1 therefore corresponds to one segment of the disk. Two magnet poles 2 and 3 which are directed opposite to one another are symbolically indicated in the right-hand part of the FIGURE. One magnet pole 2 is magnetized in the direction of the plane of the drawing, that is to say its direction of magnetization is perpendicular to the plane of the drawing and points into said plane of the drawing. In contrast, the other magnet pole 3 is magnetized out of the plane of the drawing. The direction of magnetization of said other magnet pole accordingly points out of the plane of the drawing. Magnet poles are also contained in the other pole pitches 1. The direction of magnetization of said magnet poles alternates from pole pitch to pole pitch in the circumferential direction. Each of the magnet poles 2, 3 is excited by permanent magnets.

In order to avoid a magnetic short circuit, pole gaps 4 have to be provided between the magnet poles 2, 3. Therefore, the magnets of the magnet poles are narrower than the pole pitch 1. In this case, these pole gaps 4 accommodate the winding or coils 5. In order to fix the coils, the pole gaps 4 can be cast after the coils are inserted. This also reduces the air eddy losses.

In order to intensify the magnetic field, the coil should be wound around a ferromagnetic component. In the case of a return path, which the disk illustrates as a support, which is composed of, for example, soft ferrite or SMC, this is possible in a particularly simple manner. To this end, the disk is specifically sawn or milled into a star shape along the borders of the pole pitch. This produces small columns of ferrite/SMC around which the winding or coil 5 can be placed.

The coils can be cylindrical coils which are simple to manufacture and which are provided in the shape of the contour of the magnets. Windings on a (flexible) conductor track are also feasible.

Therefore, one winding or coil 5 is provided around each permanently excited magnet pole 2, 3. Since adjacent poles are in each case magnetized in opposite directions, the direction of winding around each magnet has to be changed. As a result, the coils can be interconnected to form a series circuit and the same direct current can be supplied to all of said coils. As an alternative, all of the magnet poles could also be provided with coils with the same direction of winding, and the coils of adjacent magnet poles are then supplied with current in opposite directions. The latter requires more complex circuitry.

The fields of all of the magnets are either intensified or weakened by feeding a direct current into the winding or the coils 5 which are connected in series. The intensity of the magnetic field of the coils is dependent on the number of turns, the intensity of the current and any possible intensification of the field by soft-magnetic core materials.

In the example in the FIGURE, a direct current I_{DC} is fed into the upper connection of the coil 5 of the magnet pole 2, so that it flows out again at the lower connection. This excites a magnetic field which is directed out of the plane of the drawing. It therefore weakens the magnetic field which is excited by the permanent magnets in the direction into the plane of the drawing.

Since, in the case of the magnet pole 3, the winding 5 has an opposite direction of winding, the direct current I_{DC} flows into the coil at the lower connection and out of said coil at the upper connection. The current therefore flows in the clockwise direction and therefore excites a magnetic field which is directed into the plane of the drawing. It therefore likewise weakens the magnetic field which is excited by the permanent magnets of the magnet pole 3 which is directed out of the plane of the drawing.

The current intensity of the direct current which supplies the coils 5 is controlled or regulated, for example, by means of a control device which receives signals from one or more sensors. Sensors of this kind can be, for example, temperature sensors or overload sensors. An overload sensor determines, for example, shaking of the gear mechanism which occurs when the gear mechanism “spins” on account of overload. “Spinning” of this kind can, for example, also be electrically registered at the stator.

There are numerous reasons for the change in the magnetic field of the magnet poles of a magnetic gear mechanism by impressing a direct current. For example, a magnetic gear mechanism is used in a mill. If materials of different hardness are ground in the mill, the tilting moment of the gear mechanism has to be accordingly set in order to protect the drive train. The direct current is accordingly adjusted in order to set the tilting moment.

A further reason for changing the magnetic field in a magnetic gear mechanism can be that the magnetic gear mechanism is heating up. Heating up of the magnets reduces their induction, so that the maximum torque which can be transmitted falls due to the heating (losses proportional to the rotation speed). This weakening in the field can be compensated by superimposing an electrically excited magnetic field with the same direction.

Furthermore, a magnetic gear mechanism can “spin” due to overload. This produces severe vibrations since the magnetic fields of the rotors are still at a maximum level. According to the invention, the magnetic fields are then deliberately weakened by impressing a corresponding current in order to minimize the shaking.

A further reason for changing the magnetic field can be that of again more quickly synchronizing the gear mechanism after falling out of sync. The field can be briefly intensified to this end.

Furthermore, in the case of a run-up process, not only the load torque, but also the moment of inertia of the rotors have to be overcome. The magnetic field can then be intensified during the run-up process. In this case, the magnets have to be designed only for the load torque.

The energy for supplying the winding can be transmitted to the rotor by slip rings or inductive transmitters. It is also feasible to use motors with integrated energy transmission to the rotor.

The dynamics during the run-up process, the situation of falling out of sync and the re-synchronization are advantageously improved by the invention in comparison to known magnetic gear mechanisms. This is achieved by the use of a DC winding which is simple to produce. In order to either magnetically intensify or weaken all of the poles at the same time (naturally not beyond the irreversible point), the windings are either wound in opposite directions or the windings are supplied with current in opposite directions.

### LIST OF REFERENCE SYMBOLS

1 Pole pitch
2 Magnet pole
3 Magnet pole
4 Pole gaps
5 Coils
I_{DC} Direct current

What is claimed is:

1.-10. (canceled)

11. A magnetic gear mechanism, comprising:
a stator;
a first rotor magnetically coupled to the stator, said first rotor having permanently excited magnet poles and coils wound around the magnet poles in one-to-one correspondence and connected in series so as to realize a first series circuit which can be supplied with direct current to change a magnetic flux through the magnet poles of the first rotor in comparison to a de-energized state; and
a second rotor magnetically coupled to the stator, said second rotor having permanently excited magnet poles.

12. The magnetic gear mechanism of claim 11, wherein the second rotor has coils wound around the magnet poles of the second rotor in one-to-one and connected in series so as to realize to a second series circuit which can be supplied with direct current to realize the second series circuit to change a magnetic flux through the magnet poles of the second rotor in comparison to a de-energized state.

13. The magnetic gear mechanism of claim 11, wherein each coil has a winding direction which depends on a direction of magnetization of permanent magnets of the magnet poles.

14. The magnetic gear mechanism of claim 13, wherein adjacent magnet poles are magnetized in opposite directions by permanent magnets, with the associated coils having an opposite winding direction in relation to one another.

15. The magnetic gear mechanism of claim 11, wherein each of the magnet poles has a soft-magnetic core.

16. The magnetic gear mechanism of claim 11, further comprising a soft-magnetic disk for arrangement of the magnet poles of the first rotor in segments in spaced apart relationship to define pole gaps which form slots for accommodating the coils.

17. The magnetic gear mechanism of claim 11, further comprising a temperature sensor configured to output a temperature signal, and a control device configured to control the direct current through the coils depending on the temperature signal.

18. The magnetic gear mechanism of claim 11, further comprising an overload sensor configured to output an overload signal, and a control device configured to control the direct current through the coils depending on the overload signal.

19. The magnetic gear mechanism of claim 11, further comprising a control device configured to control the direct current through the coils such that the magnetic flux through the magnet poles during a prespecified start-up phase of the first rotor is intensified in comparison to the de-energized state.

20. A method for operating a magnetic gear mechanism, comprising:
providing each of a plurality of permanently excited magnet poles of a first rotor with a coil, with the coils of the magnet poles being connected in series so as to realize a first series circuit; and
supplying direct current to the first series circuit of the coils to thereby change a magnetic flux through the magnet poles of the first rotor in comparison to a de-energized state.

21. The method of claim 20, further comprising providing each of a plurality of permanently excited magnet poles of a second rotor with a coil, with the coils of the magnet poles of the second rotor being connected in series so as to realize a second series circuit, and supplying direct current to the second series circuit of the coils to thereby change a magnetic flux through the magnet poles of the second rotor in comparison to a de-energized state.
